(19) United States
(12) Patent Application Publication
(10) Pub. No.: US 2009/0306827 A1
(43) Pub. Date: Dec. 10, 2009

(54) Display device and household appliance including the same

(75) Inventors: Hyeng Kyun Kim, Yongin-si (KR); Sang Yun Lee, Seoul (KR); Min Sul Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/453,355

(22) Filed: May 7, 2009

(30) Foreign Application Priority Data
Jun. 9, 2008 (KR) 10-2008-53632

(51) Int. Cl. G05B 15/00

(52) U.S. Cl. 700/275

(57) ABSTRACT

Disclosed herein are a display device capable of preventing a buyer from arbitrarily switching a demo mode or a function control mode in an exhibition room, and a household appliance including the same. The household appliance includes a main body and a control device provided in the main body to control at least one function of the appliance, and at least one of a first display device electrically connected to the control device to display an operation state of the appliance controlled by the control device and a second display device to perform a demo function of the appliance is selectively mounted.

### CROSS-REFERENCE TO RELATED APPLICATIONS

This application claims the priority benefit of Korean Patent Application No. 2008-0053632, filed on Jun. 9, 2008 in the Korean Intellectual Property Office, the disclosure of which is incorporated herein by reference.

### BACKGROUND

1. Field

Embodiments relate to a display device and a household appliance including the same, and, more particularly, to a display device, which is capable of performing a demo mode to present or advertize appliance information to buyers, and a household appliance including the same.

2. Description of the Related Art

Generally, electric appliances used at home are called household appliances. Household appliances include but are not limited to a refrigerator, a washing machine, an air conditioner, a dish washer, a microwave oven and a cooking oven.

In the initial stage of such household appliances, appliances including only simple control buttons such as an on/off button, an operation start/stop button, a temperature control button, various setting value increasing/decreasing buttons and numeric keys were mainly used. However, with the development of technology, appliances each including various types of control buttons and a display device including a display unit to directly display an operation state of the appliance have been continuously released.

As the display unit, a liquid crystal display (LCD) is mainly used. Such an LCD is disposed on a front surface or an upper surface of a household appliance so as to allow a user to view an LCD screen, thereby checking a current operation state of the household appliance.

Various control buttons are provided on the circumference of the LCD screen so as to allow the user to control the appliance using the control buttons. In addition, the controlled state can be checked using the display unit.

Accordingly, the user of the household appliance operates the control buttons so as to send a predetermined command to the household appliance. Then, a controller (microcomputer or the like) of the household appliance generates a control signal corresponding to the command so as to perform the command, and the display unit displays the operation state of the household appliance.

A display unit of a refrigerator may, for example, display a current time, the setting temperatures and the current temperatures of compartments, operation modes of the compartments which are currently set, and so on. As another example, a display unit of an air conditioner may display a setting temperature, a current temperature, an operation state of an outdoor unit and so on.

Recently, as the functions of the household appliances become complicated, a difficulty arises when a seller knows various functions of the household appliances and explains the functions to buyers.

As an example of solving such a difficulty, U.S. Pat. No. 6,993,485 discloses a refrigerator with an integrated presentation mode.

The refrigerator disclosed in the above publication includes a cabinet, a compartment disposed within the cabinet, a display operatively connected to the cabinet, and a controller electrically connected to the display. At this time, the controller is adapted to provide an appliance message related to the refrigerator on the display or to control the function of the refrigerator.

The display of U.S. Pat. No. 6,993,485 allows a user to select a mode for providing an appliance message by a refrigerator exhibited in an exhibition room or a mode for controlling the function of the refrigerator. Accordingly, it is possible to provide the appliance message such as an appliance advertisement to buyers, if necessary, or to select the mode for controlling the function of the refrigerator when the refrigerator is purchased and installed in the home or shop.

However, in the refrigerator disclosed in the above publication, a buyer of the exhibition room can arbitrarily select the mode for providing the appliance message or the function control mode. Therefore, if the mode for controlling the function of the refrigerator is selected and the control buttons of the function control mode are frequently operated, the durability of the appliance may deteriorate.

Since the function control mode of the appliance can be selected even in the exhibition room, power consumption is increased due to the motion of a compressor at the time of the function control mode.

### SUMMARY

According to exemplary embodiments, there may be provided a display device capable of preventing a buyer from arbitrarily switching an appliance message provision mode (hereinafter, referred to as a “demo mode”) or a function control mode in an exhibition room, and a household appliance including the same.

According to exemplary embodiments, there may be provided a display device to perform only a demo mode or a display device to perform only a function control mode, which is detachably mounted in a household appliance, and a household appliance including the same.

Additional aspects will be set forth in part in the description which follows and, in part, will be obvious from the description, or may be learned by practice of the disclosure.

According to exemplary embodiments, there may be provided an input voltage monitoring apparatus comprising: input voltage detector to generate a high or low signal based on a level of an input voltage inputted to an electric appliance; and a microcomputer for measuring a duration of the high or low signal and determining the level of the input voltage on the basis of the measured duration.

According to exemplary embodiments, there may be provided a household appliance including a main body forming the appearance of the appliance and a control device provided in the main body in order to control a function of the appliance, wherein at least one of a first display device electrically connected to the control device to display an operation state of the appliance controlled by the control device and a second display device to perform a demo function of the appliance is selectively mounted.

The demo function may provide performance and information of the appliance.

The second display device may include a memory to store contents for the demo function of the appliance and a sub-controller connected to the memory to control the demo function.

The sub-controller of the second display device may display a data value of the memory without communicating with the control device when a signal to control the appliance is received.

The second display device may further include an input port connected to an external storage medium.

Each of the first and second display devices may further include a data input/output terminal to input/output data to/from the control device and a power input terminal to input power, and the data input/output terminal of the second display device may be disconnected such that the input/output of the data to/from the control device is prevented.

Each of the first and second display devices may further include a touch screen.

The main body may further include a mounting part in which any one of the first and second display devices is mounted, and each of the first and second display devices may be detachably connected to the mounting part.

The household appliance may be any one of a refrigerator, a washing machine or an air conditioner.

According to exemplary embodiments, there may be provided a household appliance including a main body forming the appearance of the appliance, a control device provided in the main body in order to control the function of the appliance, and a display device to perform a demo function of the appliance, wherein the display device is driven independent of an operation of the control device.

The main body may further include a mounting part in which the display device is mounted, and the display device is detachably connected to the mounting part.

The demo function may provide performance and information of the appliance.

The main body may further include a data wire connected to the control device to exchange data and a power wire to supply power to the display device, and the display device may be connected to the power wire and may be disconnected from the data wire.

The display device may further include a touch screen to output an image and input a signal, and a speaker to output an audio signal.

The display device may include a memory to store contents for the demo function of the appliance, and a sub-controller connected to the memory to control the demo function.

According to exemplary embodiments, there may be provided a display device mounted in a household appliance including a main body and a control device provided in the main body, the display device including: a power connection terminal connected to an external power supply; a memory to store contents for performing a demo function of the household appliance; and a display unit to display the demo function of the household appliance.

The display unit may include a touch screen to perform an input/output function.

The display device may further include a sub-controller connected to the memory so as to be driven independent of the main body, and the sub controller may control the demo function stored in the memory.

The sub controller may prevent data from being input/output to/from the control device.

According exemplary embodiments of a display device and a household appliance including the same, since a second display device to perform a demo function can be mounted in the household appliance, the control of the appliance is prevented when the appliance is exhibited for sale. Thus, power consumption at the time of the exhibition of the appliance can be reduced.

According to exemplary embodiments, there may be provided a household appliance for receiving one of a first removable display device and a second removable display device, the household appliance including a control device to control at least one function of the appliance, wherein the first removable display device is electrically connected to the control device to display an operation state of the appliance controlled by the control device during physical operation of the appliance; and the second removable display device includes a sub-controller connected to a display unit to perform a demo function of the appliance independent of the operation of the control device during a virtual demonstration of the appliance.

In addition, since it is possible to prevent a buyer from controlling the function of the appliance at the time of the exhibition of the appliance, it is possible to prevent the life span of the appliance from being shortened.

Since a memory for the demo function is provided in the second display device to perform the demo function, the capacity of the memory of the control device included in the main body can be reduced compared with the related art and thus the manufacturing cost of the control device can be reduced. Since the same control device can be mounted in the household appliance regardless of existence/nonexistence of the demo function, the control device can be widely used.

### BRIEF DESCRIPTION OF THE DRAWINGS

These and/or other aspects of exemplary embodiments will become apparent and more readily appreciated from the following description, taken in conjunction with the accompanying drawings of which:

FIG. 1 is a perspective view showing a household appliance according to an exemplary embodiment;

FIG. 2 is a partial perspective view showing the household appliance and a display device included therein, according to the exemplary embodiment;

FIG. 3 is a block diagram of a first display device mounted in the household appliance according to the exemplary embodiment;

FIG. 4 is a block diagram of a second display device mounted in the household appliance according to the exemplary embodiment; and

FIG. 5 is a front view showing the driving state of the display device included in the household appliance according to the exemplary embodiment.

### DETAILED DESCRIPTION

Reference will now be made in detail to exemplary embodiments, examples of which are illustrated in the accompanying drawings, wherein like reference numerals refer to the like elements throughout.

Hereinafter, a display device and a household appliance including the same according to exemplary embodiments will be described with reference to the accompanying drawings.

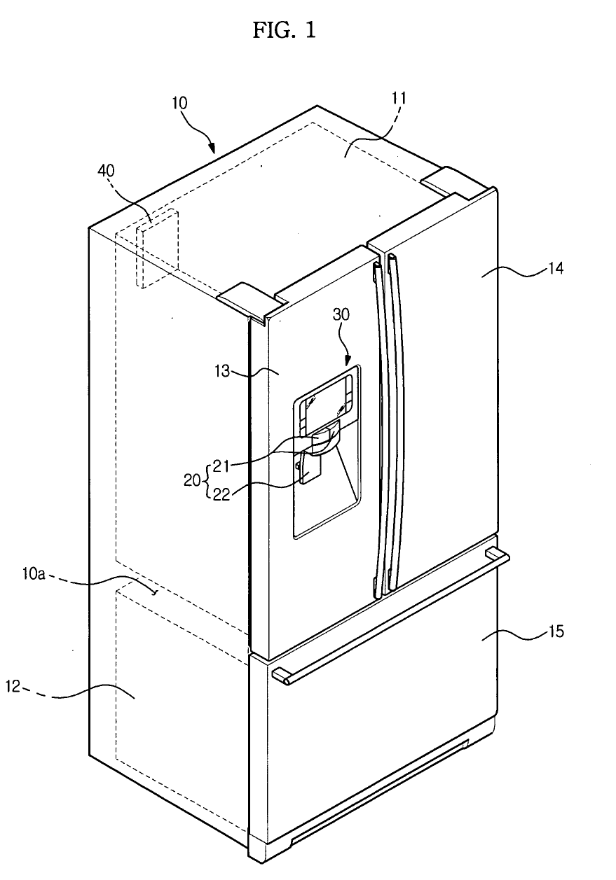

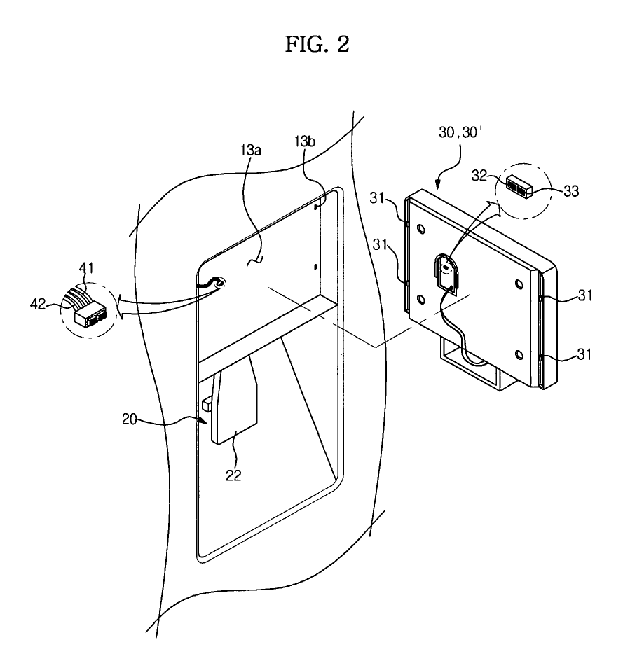

FIG. 1 is a perspective view showing a household appliance according to an exemplary embodiment, and FIG. 2 is a partial perspective view showing the household appliance and a display device included therein according to an exemplary embodiment.

Embodiments can be applicable to a household appliance including a display device, such as a refrigerator, a washing machine, an air conditioner, a dish washer, a microwave oven, a cooking oven or the like. For example, the refrigerator will be described.

The refrigerator according to an exemplary embodiment includes, as shown in FIGS. 1 and 2, a main body 10 including compartments 11 and 12, each of which a front surface can be opened, and doors 13, 14 and 15 to open and close the compartments 11 and 12.

The compartments 11 and 12 include a refrigeration compartment 11 and a freezing compartment 12 partitioned by a horizontal partition 10a. The doors 13, 14 and 15 include a pair of refrigeration compartment doors 13 and 14 which is hinge-coupled to the both sides of the refrigerator so as to open and close the refrigeration compartment 11 and the freezing compartment door 15 which is slidably provided so as to open and close the freezing compartment 12.

A control device 40 to control various electric/electronic components in the main body 10 is disposed on a back surface of the main body 10.

Although not shown, evaporators (not shown) to cool the compartments 11 and 12 are disposed on the inner back sides of the compartments 11 and 12, a mechanical compartment (not shown) partitioned from the compartments 11 and 12 are disposed on a lower side of the main body 10, and a compressor (not shown), a condenser (not shown) and a refrigerant expansion device (not shown) are provided in the mechanical compartment.

A dispensing device 20 to dispense water and ice is provided in the refrigeration door 13. The dispensing device 20 includes a selection button 21 to select water and ice and a driving lever 22 to drive the dispensing device 20 such that water or ice selected by the selection button 21 is discharged.

At this time, if the water is selected by the selection button, water stored in a water tank (not shown) of the refrigeration compartment 11 is dispensed and, if the ice is selected, ice made in an ice making compartment (not shown) partitioned in the refrigeration compartment 11 is dispensed.

The display devices 30 and 30′ included in an exemplary embodiment are disposed on the upper side of the dispensing device 20.

A mounting part 13a, which is recessed backward so as to receive the display device 30 or 30′ therein, is disposed in the front surface of the refrigeration compartment door 13 on the upper side of the dispensing device 20. The mounting part 13a includes a data wire 42 connected to a control device 40 provided in the main body 10 so as to exchange data, and a power wire 41 to supply power from a power supply 50 to the display device 30 or 30′.

At this time, the power wire 41 may extend to the display device via the control device. In an exemplary embodiment, it is assumed that the power wire bypasses the control device and directly extends to the display device.

In addition, hook coupling grooves 13b are provided in the both sides of the mounting part 13a at positions corresponding to hooks 31 so as to be coupled with the hooks 31 of the display device 30 or 30′ in order to fix the display device 30 or 31′.

As the display device 30 or 30′ mounted in the refrigeration compartment door 13, the first display device 30 which is electrically connected to the control device 40 so as to display an operation state controlled by the control device 40 or the second display device 30′ to perform a demo function to simulate the driving of the refrigerator or instruct a buyer in the usage at the time of exhibition for sale of the refrigerator may be selectively mounted.

At this time, since the first and second display devices 30 and 30′ are equal to each other except a portion of the components, only the first display device 30 will be described with respect to the same portion and the portion of the second display device 30′ different from that of the first display device 30 will be described later.

As shown in FIG. 2, the plurality of hooks 31 are provided on the both sides of the back surface of the first display device 30 so as to be coupled to the hook coupling grooves 13b, and a data input/output terminal 33 connected to the data wire 42 and a power input terminal 32 connected to the power wire 41 are provided on the inner side of the back surface of the first display device 30.

An input port 34 connected to an external storage medium may be provided in the first display device 30.

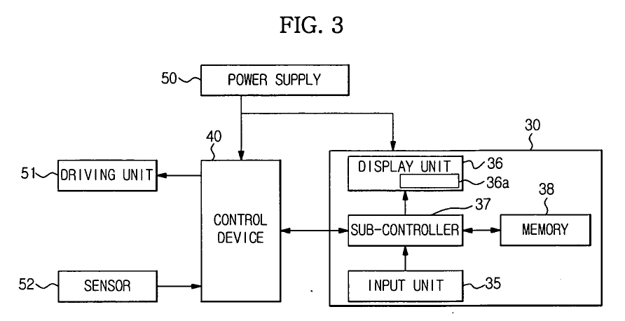

FIG. 3 is a block diagram of the first display device mounted in the household appliance according to an exemplary embodiment.

As shown in FIG. 3, the first display device 30 includes an input unit 35 to input a control command, a display unit 36, a sub-controller 37, and a memory 38.

The input unit 35 includes control buttons such as an on/off button, a temperature control button, and various setting value increasing/decreasing buttons.

An LCD may be included as the display unit 36. In an exemplary embodiment, the display unit includes a touch screen.

In the touch screen, for example, several resistance lines are arranged in the display unit, a position touched by a user's hand is read by a variation in resistance value generated in a resistance line of the touched position due to static electricity and is displayed on the display unit 36, and a control signal corresponding to the position is generated so as to perform the control of the sub-controller 37.

That is, the touch screen performs the function of the display unit 36 to output an image and the function of the input unit 35 to input a signal.

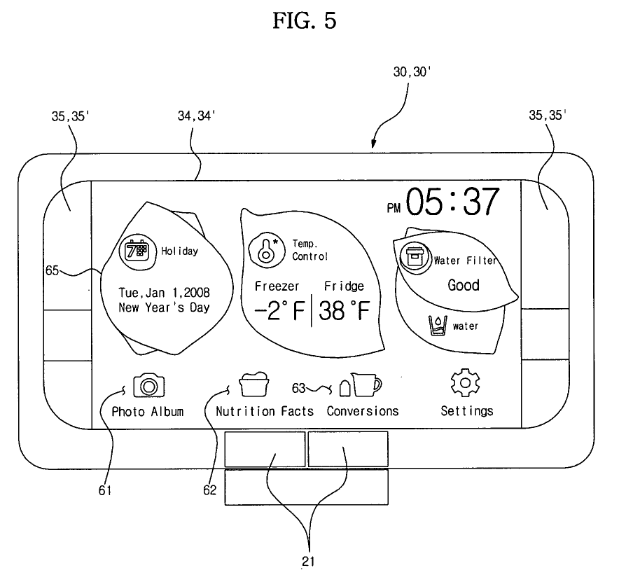

As shown in FIG. 5, the display unit 36 may display the setting temperature and the current temperature of the refrigerator, the current state of a water filter and a calendar. The display unit 36 may include a speaker 36a to output an audio signal.

The sub-controller 37 recognizes the touch of the user on the display unit 36 and displays data stored in the memory 38 on the display unit 36 according to the user's requirement.

The memory 38 provided in the first display device 30 stores data related to functions unrelated to the control of the main body 10 of the refrigerator, that is, a “photo album” function 61, a “nutrition facts” function 62 and a “conversions” function 63. Data related to the control of the main body 10 of the refrigerator is stored in a RAM (not shown) provided in the control device 40 of the main body 10.

The memory 38 may store the photograph of the appliance in association with the “photo album” function 61 as a default and read and output a photographic file from the external storage medium connected to the input port 34.

In addition, the memory 38 may store information about food in association with the “nutrition facts” function 62 and output calorie and nutritive components included in selected food on the display unit 36 as an image. The memory 38 may store a unit conversion table in association with the “conversions” function 63 and convert, for example, centigrade into Fahrenheit or convert an International system (SI) unit or a U.S customary system (USCS) unit.

In an exemplary embodiment, a mode for controlling the function of the main body on the basis of the signal received from the input unit 35 is called a function control mode. The function control mode includes the control of the temperature of the refrigerator, the selection of water or ice, quick refrigeration and quick freezing.

A mode for outputting an image, which is displayed on a display device when the main body 10 is actually controlled, on the display unit without actually controlling the main body 10 if a driving signal for controlling the function is applied by the input unit of the display device and displaying the operation state of the main body 10 and the operating method of the appliance to the user so as to provide the performance and the information of the appliance is called a demo mode.

The refrigerator including the first display device 30 according to an exemplary embodiment further includes the power supply 50, the control device 40, a driving unit 51 and a sensor 52, as shown in FIG. 3.

The power supply 50 supplies power to the control device 40 and supplies power to the first display device 30 via the power wire 41 connected to the power input unit 32 of the first display device 30.

The control device 40 controls the components of the refrigerator and serves to detect a control signal of the input unit 35 and a control signal of the sensor, apply the control signals to the driving unit 51 of the components, and display the control signals on the display unit 36.

The driving unit 51 drives the compressor, various types of ventilation fans, a lamp in the refrigerator, an ice making device and drives the components according to signals of the control device 40.

The sensor 52 transmits signals sensed by various types of sensors to the control device 40.

Accordingly, when the refrigerator including the first display device 30 receives signals unrelated to the control of the refrigerator via the input unit 35, the sub-controller 37 controls the data stored in the memory 38 to be displayed on the display unit 36.

When the signals related to the control of the refrigerator, that is, the signals corresponding to the function control mode of the refrigerator, are received via the input unit 35, the signals are transmitted to the control device 40 provided in the main body 10 via the sub-controller 37. The control device 40 controls the components on the basis of the input signals, transmits the signals to the sub-controller 37, and outputs the signals on the display unit 36 as an image.

In addition, when the signals unrelated to the control of the refrigerator, that is, the signals for the “photo album” function 61, the “nutrition facts” function 62 and the “conversions” function 63, are received via the input unit 35, the sub-controller 37 reads the data stored in the memory and outputs the data on the display unit 36 as an image.

Next, a second display device 30′ of the refrigerator according to an exemplary embodiment will be described.

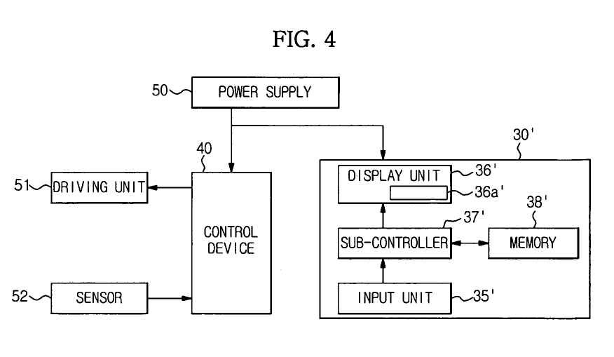

FIG. 4 is a block diagram of a second display device 30 ′ mounted in the household appliance according to an exemplary embodiment.

As shown in FIG. 4, the second display device 30′ includes an input unit 35′ to input a control command, a display unit 36′, a sub-controller 37′ and a memory 38′.

The second display device 30′ is similar to the first display device 30 in that the input unit 35′, the display unit 36′, the sub-controller 37′, and the memory 38′ are included, and is different from the first display unit 30′ in that contents for the demo function, that is, data which will be output when the signal related to the control of the refrigerator is input, are stored in the memory 38′ of the second display device 30′ and the sub-controller 37′ reads the data stored in the memory 38′ without communicating with the control device 40 of the main body 10 and outputs the data to the display unit 36′ when the signal related to the control of the refrigerator is received.

The second display device 30′ is substantially the same as the first display device 30 as described above, but does not include the data input/output terminal 33 connected to the data wire 42 extending from the control device 40 of the main body 10.

Accordingly, when the second display device 30′ is mounted in the main body 10, data communication between the control device 40 of the main body 10 and the second display device 30′ is not performed although the signal related to the control of the refrigerator is received from the input unit 35′. Therefore, the components of the main body 10 are not actually controlled and virtual data values stored in the memory 38′ are output to the display unit 36′.

Even when a buyer performs the operation for controlling the function of the main body 10 in an exhibition room, the function control mode is not implemented and only the demo mode for displaying the state of virtually driving the main body 10 on the second display device 30′ is implemented.

When the second display device 30′ is mounted, the components requiring high power consumption, such as the compressor, may not be driven and the lamp in the refrigerator (not shown) may be set to be turned on/off when the door is opened and closed. Accordingly, when an appliance is exhibited in the exhibition room, power consumption can be reduced and a buyer can know the operation method and the function of the appliance.

When an appliance is mounted and driven in the home, the second display device is detached, the first display device is attached, and the function control mode is performed, thereby controlling the appliance.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A household appliance comprising a main body and a control device provided in the main body to control at least one function of the appliance,
wherein at least one of a first display device electrically connected to the control device to display an operation state of the appliance controlled by the control device and a second display device to perform a demo function of the appliance is selectively mounted.

2. The household appliance according to claim 1, wherein the demo function provides performance and information of the appliance.

3. The household appliance according to claim 1, wherein the second display device includes a memory to store contents for the demo function of the appliance, and a sub-controller connected to the memory to control the demo function.

4. The household appliance according to claim 3, wherein the sub-controller of the second display device displays a data value of the memory without communicating with the control device when a signal to control the appliance is received.

5. The household appliance according to claim 1, wherein the second display device further includes an input port connected to an external storage medium.

6. The household appliance according to claim 1, wherein:
each of the first and second display devices further includes a data input/output terminal to input/output data to/from the control device and a power input terminal to input power, and
the data input/output terminal of the second display device is disconnected such that the input/output of the data to/from the control device is prevented.

7. The household appliance according to claim 1, wherein each of the first and second display devices further includes a touch screen.

8. The household appliance according to claim 1, wherein the main body further includes a mounting part in which any one of the first and second display devices is mounted, and each of the first and second display devices is detachably connected to the mounting part.

9. The household appliance according to claim 1, wherein the household appliance is any one of a refrigerator, a washing machine, or an air conditioner.

10. A household appliance comprising a main body, a control device provided in the main body to control at least one function of the appliance, and a display device to perform a demo function of the appliance,
wherein the display device is driven independent of an operation of the control device.

11. The household appliance according to claim 10, wherein the main body further includes a mounting part in which the display device is mounted, and the display device is detachably connected to the mounting part.

12. The household appliance according to claim 10, wherein the demo function provides performance and information of the appliance.

13. The household appliance according to claim 10, wherein:
the main body further includes a data wire connected to the control device to exchange data and a power wire to supply power to the display device, and
the display device is connected to the power wire and is disconnected from the data wire.

14. The household appliance according to claim 10, wherein the display device further includes a touch screen to output an image and input a signal, and a speaker to output an audio signal.

15. The household appliance according to claim 10, wherein the display device includes a memory to store contents for the demo function of the appliance, and a sub-controller connected to the memory to control the demo function.

16. A display device mounted in a household appliance including a main body and a control device provided in the main body, the display device comprising:
a power connection terminal connected to an external power supply;
a memory to store contents used to perform a demo function of the household appliance;
a sub-controller connected to the memory to control the demo function of the household appliance using the contents; and
a display unit to display the demo function of the household appliance.

17. The display device according to claim 16, wherein the display unit includes a touch screen to perform an input/output function.

18. The display device according to claim 16, wherein the sub-controller is driven independent of operation of the control device.

19. The display device according to claim 18, wherein the sub controller prevents data from being input/output to/from the control device.

20. A household appliance for receiving one of a first removable display device and a second removable display device, the household appliance comprising a control device to control at least one function of the appliance, wherein:
the first removable display device is electrically connected to the control device to display an operation state of the appliance controlled by the control device during physical operation of the appliance; and
the second removable display device includes a sub-controller connected to a display unit to perform a demo function of the appliance independent of the operation of the control device during a virtual demonstration of the appliance.
